(19) United States
(12) Patent Application Publication
(10) Pub. No.: US 2024/0168507 A1
(43) Pub. Date: May 23, 2024

(54) BANDGAP VOLTAGE REFERENCE CIRCUIT WITH CURRENT MIRROR LOOP

(71) Applicant: TEXAS INSTRUMENTS INCORPORATED, Dallas, TX (US)

(72) Inventors: Sandeep Krishnan, Bangalore (IN); Tallam Vishwanath, Bangalore (IN); Akshay Jadhav, Bangalore (IN)

(21) Appl. No.: 18/307,320

(22) Filed: Apr. 26, 2023

(30) Foreign Application Priority Data
Nov. 22, 2022 (IN) 202241066888

(51) Int. Cl. G05F 3/20; G05F 1/575; G05F 3/26

(52) U.S. Cl. CPC G05F 3/205; G05F 1/575; G05F 3/265

(57) ABSTRACT

A bandgap reference circuit includes a first diode-coupled transistor having a first control terminal and first and second current terminals and a second transistor having a second control terminal and third and fourth current terminals. The second control terminal is coupled to the first control terminal. A third transistor have a third control terminal and fifth and sixth current terminals. A fourth diode-coupled transistor has a fourth control terminal and seventh and eighth current terminals. The fourth control terminal is coupled to the third control terminal. An operational amplifier has a first input, a second input, and an output. The output is coupled to the first current terminal. A first resistor is coupled between the output and the third current terminal. A second resistor is coupled between the sixth and eighth current terminals.

### CROSS-REFERENCE TO RELATED APPLICATIONS

This application claims priority to India Provisional Application No. 2022410668, filed Nov. 22, 2022, which is hereby incorporated by reference.

### BACKGROUND

Bandgap voltage reference circuits are used in various electronic systems. A bandgap voltage reference circuit provides an output reference voltage for use, for example, by other circuitry within the electronic system. The output reference voltage produced by a bandgap reference circuit is generally constant despite fluctuations in the power supply, load current, and temperature of the electronic system.

### SUMMARY

In one example, a bandgap reference circuit includes a first diode-coupled transistor having a first control terminal and first and second current terminals and a second transistor having a second control terminal and third and fourth current terminals. The second control terminal is coupled to the first control terminal. A third transistor has a third control terminal and fifth and sixth current terminals. A fourth diode-coupled transistor has a fourth control terminal and seventh and eighth current terminals. The fourth control terminal is coupled to the third control terminal. An operational amplifier has a first input, a second input, and an output. The output is coupled to the first current terminal. A first resistor is coupled between the output and the third current terminal. A second resistor is coupled between the sixth and eighth current terminals.

### BRIEF DESCRIPTION OF THE DRAWINGS

FIG. 1 is a schematic of an example bandgap voltage reference circuit.

FIG. 2 is a schematic of another example of a bandgap voltage reference circuit.

FIG. 3 is a schematic of yet another example of a bandgap voltage reference circuit.

### DETAILED DESCRIPTION

The same reference numbers or other reference designators are used in the drawings to designate the same or similar (either by function and/or structure) features.

As mentioned above, bandgap voltage reference circuits provide generally constant, high-precision reference voltages in the face of various fluctuating parameters including ambient temperature, power supply voltage, and load current. Many bandgap voltage reference circuits include one or more bipolar junction transistors (BJTs). The base-to-emitter voltage (Vbe) of a BJT typically is complementary to absolute temperature (CTAT). At least some bandgap voltage reference circuits operate on the principle of offsetting the BJTs' CTAT dependence with a current that is proportional to absolute temperature (PTAT), thereby resulting in the bandgap voltage reference circuit's output voltage having very little if any dependence on temperature.

Several sources of noise may be present in a bandgap voltage reference circuit. One type of noise is a relatively low frequency noise (e.g., 0.1 to 10 Hz) associated with an operational amplifier (OP AMP) present in the circuit. The OP AMP's noise may cause changes in the bandgap voltage produced by the bandgap voltage reference circuit. The OP AMP's noise may be modeled as an input-referred noise associate with one of the OP AMP's input terminals. Unfortunately, for some bandgap voltage reference circuits, the ratio (also referred to as gain) of the change in the bandgap voltage to the change in the OP AMP's input referred noise may be substantial (e.g., a gain of 2, 3, 4, etc.). For example, a gain of 4 means that for a 1 mV input-referred noise offset, the output bandgap voltage may change by 4 mV. The examples described herein are directed to a bandgap voltage reference circuit that addresses this issue, and advantageously has a lower gain (e.g., approximately unity gain).

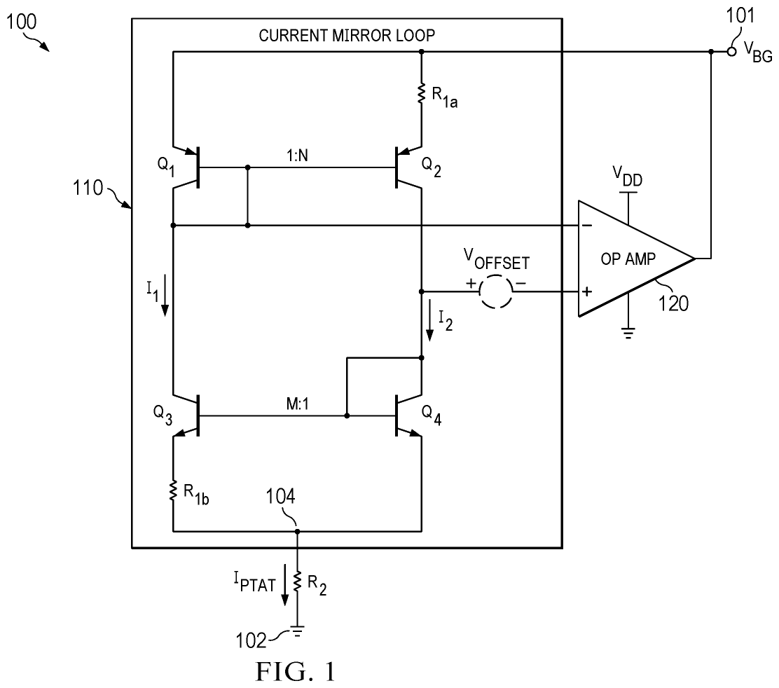

FIG. 1 is a schematic of a bandgap voltage reference circuit 100, in accordance with an example. In the example of FIG. 1, the bandgap voltage reference circuit 100 includes a current mirror loop 110 and an OP AMP 120. The current mirror loop includes transistors Q₁, Q₂, Q₃, and Q₄ and resistors R₁ₐ, R_{1b}, and R₂ (resistor R2 may be outside or inside the current mirror loop 110). OP AMP 120 includes a negative (−) input, a positive (+) input, and an output. Transistors Q₁ and Q₂ are PNP BJTs, and transistors Q₃ and Q₄ are NPN BJTs. The collectors of transistor Q₁ and Q₃ are coupled together and to the OP AMP's negative input. The collectors of transistors Q₂ and Q₄ are coupled together and to the positive input of OP AMP 120. Resistor R₂ is coupled between the emitter of transistor Q₄ at node 104 and the power supply reference terminal 102 (e.g., ground). Resistor R_{1b} is coupled between the emitter of transistor Q₃ and resistor R₂ at node 104. The output of OP AMP 120 is coupled to the emitter of transistor Q₁. Resistor R₁ₐ is coupled between the OP AMP's output and the emitter of transistor Q₂. The output of the OP AMP 120 provides the output bandgap voltage V_{BG} at an output terminal 101.

The bases of transistors Q₁ and Q₂ are coupled together. The ratio of the size of transistor Q₁ to transistor Q₂ is 1:N. The combination of transistors Q₁ and Q₂ and resistor R₁ₐ forms a current mirror in which current I₁ through transistor Q₁ is approximately equal to current I₂ through transistor Q₂. Similarly, the bases of transistors Q₃ and Q₄ are coupled together and to the collector of transistor Q₄ and to the positive input of OP AMP 120. The ratio of the sizes of transistor Q₃ to transistor Q₄ is M:1. Transistors Q₃ and Q₄ are coupled together to form a current mirror in which, for the case in which M equals N, current I₁ through transistor Q₃ is approximately equal to current I₂ through transistor Q₄. Currents I₁ and 12 add together to form current I_{PTAT} through resistor R₂.

For an ideal OP AMP, the voltages on the positive and negative inputs are equal. Accordingly, the output bandgap voltage V_{BG} is the sum of the Vbe_Q1 (Vbe of transistor Q₁), the Vbe_Q2 (Vbe of transistor Q₂), and the voltage drop across resistor R₂. The voltage drop across transistor R₂ is the product of the resistance of resistor R₂ and current I_{PTAT}. Thus, the output bandgap voltage V_{BG} equals Vbe_Q1+Vbe_Q2+(R₂*I_{PTAT}). As described above, the Vbe of a BJT has a CTAT temperature dependence. Assuming the resistance of resistors R₁ₐ and R_{1b} are equal to each other and denoting that equal resistance as R₁, then current I₁, which equals current I₂, equals V_{T}*ln(N), where V_{T} is the transistor's thermal voltage, “ln” is the natural logarithm operator, and “N” is the ratio of the sizes of transistors Q₁ and Q₂ as mentioned above. The transistor's thermal voltage, V_{T}, equals kT/q, “k” is the Boltzmann constant, “T” is temperature, “q” is electric charge of an electron. Because currents I₁ and I₂ are proportional to V_{T}, currents I₁ and I₂ are PTAT currents. Because the currents I₁ and I₂, which combine to flow through resistor R₂, have a PTAT temperature dependence (and thus the voltage drop across resistor R₂ is PTAT) and the Vbe's of transistors Q₁ and Q₄ have CTAT temperature dependencies, the output bandgap voltage V_{BG} generally has very little dependence on temperature.

Noise generated by OP AMP 120 can be modeled as an input-referred voltage offset (V_{offset}) on one or the other of the OP AMP's inputs. In the schematic of FIG. 1, the input-referred voltage offset V_{offset} is modeled on the OP AMP's positive input. As mentioned above, for some bandgap voltage reference circuits, the gain of V_{BG} to V_{offset} is substantially greater than 1 (e.g., 2, 3, etc.), which means a small value of V_{offset} (OP AMP noise) has a dramatic impact on the level of V_{BG}. As described below, the current mirror loop 110 has a significantly lower V_{BG} gain relative to V_{offset} of approximately 1, and thus, due to the operation of the current mirror loop 110, the bandgap output voltage V_{BG} is impacted to a much smaller degree by any OP AMP noise.

In the steady state, the current mirror loop 110 forces the currents I₁ and 12 to remain approximately equal to each other and thus unaffected by V_{offset}. The current mirror loop 110 achieves this result by maintaining the Vbe voltages of each of the four transistors Q₁-Q₄ at approximately the same voltage value. The current through a BJT is largely determined by the value of its Vbe, and thus if the Vbe's of the transistors do not change, then neither do the currents I₁ and I₂, and thus current I_{PTAT} also remains unchanged. What does change is the voltage on node 104, which is the voltage across resistor R₂. For example, assuming an increase of V_{offset} of 1 mV, then the voltage on the bases of transistors Q₃ and Q₄ also increases by 1 mV. For currents I₁ and I₂ to remain unchanged, then the voltages on the emitters of transistors Q₃ and Q₄ will increase by 1 mV, and thus voltage on node 104 increases by 1 mV.

As described above, V_{BG} is the sum of the Vbe's of transistors Q₁ and Q₄ plus the voltage across resistor R₂. The current mirror loop 110 prevents the Vbe's of transistors Q₁ and Q₄ from changing due to input-referred noise of OP AMP 120, but the voltage across resistor R₂ (voltage on node 104) changes by the same magnitude of the change in V_{offset}. Continuing the example above, if V_{offset} increases by 1 mV, then the voltage across resistor R₂ increases by 1 mV, and the net effect on the magnitude of the output bandgap voltage V_{BG} is to increase the output bandgap voltage V_{BG} by 1 mV. Accordingly, a 1 mV change in V_{offset} results in a 1 mV change in V_{BG}, which is a gain (V_{BG}/V_{offset}) of 1.

Mechanical stress on a semiconductor device (e.g., a die on which multiple transistors are formed) can affect the Vbe of bipolar junction transistors. The Vbe of an NPN transistor may be affected to a larger degree than the Vbe of a PNP transistor. See e.g., F. Fruett et al., “Minimization of the Mechanical-Stress-Induced Inaccuracy in a Bandgap Voltage Reference.,” IEEE J. Solid-State Circuits, vol. 38, no. 7, July 2003, pp. 1288-1291. As described above, the output bandgap voltage V_{BG} is a function of the Vbe's of NPN transistors Q₁ and Q₄, as well as the voltage across resistor R₂. Because V_{BG} is a function of the Vbe's of two NPN transistors, any mechanical stress on the die containing the bandgap voltage reference circuit 100 may affect the magnitude of the output bandgap voltage V_{BG} more than if the output bandgap voltage V_{BG} was instead a function of PNP transistors.

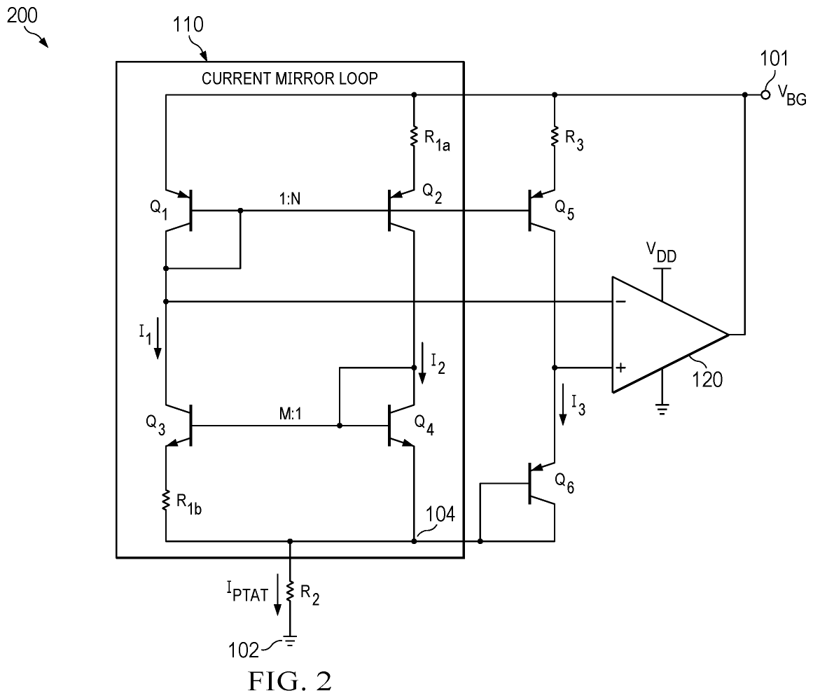

FIG. 2 is a schematic of a bandgap reference circuit 200, which includes the current mirror loop 110, OP AMP 120, additional transistors Q₅ and Q₆ and resistor R₃. In this example, transistors Q₅ and Q₆ are PNP BJTs. Resistor R₃ is coupled between output terminal 101 and the emitter of transistor Q₅. The collector of transistor Q₅ is coupled to the emitter of transistor Q₆ and to the positive input of OP AMP 120. Accordingly, the positive input of OP AMP 120 is not coupled to the collectors of transistors Q₂ and Q₄, as was the case for the bandgap reference circuit 100 in FIG. 1. The negative input of OP AMP 120 is coupled to the collectors of transistors Q₁ and Q₃ as was the case in FIG. 1. Transistor Q₆ is a diode-coupled transistor (its base is coupled to its collector) coupled between transistor Q₅ and resistor R₂ at node 104.

The base of transistor Q₅ is coupled to the bases of transistors Q₁ and Q₂. In this configuration, transistors Q₅ and Q₁ form a current mirror. In one example, transistor Q₅ is smaller than transistor Q₁, and thus the current I₃ through transistor Q₃ is a function of, but smaller than, current I₁ through transistor Q₁. Transistor Q₅ provides current I₃ as a bias current through diode-coupled transistor Q₆.

In the configuration of FIG. 2, the output bandgap voltage V_{BG} is the sum of the transistor Q₁'s Vbe, transistor Q₆'s Vbe, and the voltage across resistor R₂. Because the output bandgap voltage V_{BG} is now, in part, a function of PNP transistor Q₆, instead of NPN transistor Q₄, V_{BG} from the bandgap reference voltage circuit 200 of FIG. 2 is advantageously influenced to a smaller degree by mechanical stress than the bandgap voltage reference circuit 100 of FIG. 1.

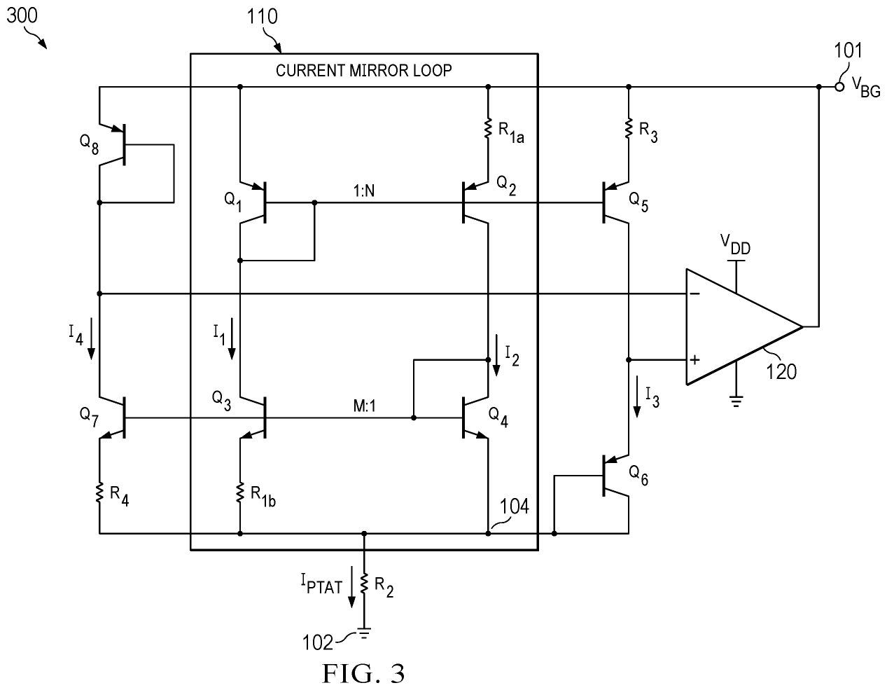

FIG. 3 is a schematic of a bandgap reference circuit 300, which includes the same current mirror loop 110, OP AMP 120, transistors Q₅ and Q₆, and resistor R₃ of FIG. 2, and additional transistors Q₇ and Q₈ and resistor R₄. In the example of FIG. 3, transistor Q₇ is an NPN transistor, and transistor Q₈ is a PNP BJT. Resistor R₄ is coupled between resistor R₂ and the emitter of transistor Q₇. The collector of transistor Q₇ is coupled to the collector and base of transistor Q₈ and to the negative input of OP AMP 120. Accordingly, the negative input of OP AMP 120 is not coupled to the collectors of transistor Q₁ and Q₃, as was the case for the bandgap reference circuits 100 and 200 in FIGS. 1 and 2, respectively. Transistor Q₈ is a diode-coupled transistor (its base is coupled to its collector) coupled between transistor Q₇ and output terminal 101.

The base of transistor Q₇ is coupled to the bases of transistors Q₃ and Q₄. In this configuration, transistors Q₇ and Q₄ form a current mirror. In one example, transistor Q₇ is smaller than transistor Q₄, and thus the current I₄ through transistor Q₇ is a function of, but smaller than, current I₂ through transistor Q₄. Transistor Q₇ provides current I₄ as a bias current through diode-coupled transistor Q₈.

In the configuration of FIG. 3, the output bandgap voltage V_{BG} is the sum of Vbe's of transistors Q₆ and Q₈ and the voltage across resistor R₂. Because V_{BG} in FIG. 3 is a function of PNP transistors Q₆ and Q₈, instead of, in part, NPN transistor Q₄ as was the case for FIG. 1, the output bandgap voltage V_{BG} from the bandgap reference voltage circuit 300 is advantageously influenced to a smaller degree by mechanical stress than the bandgap voltage reference circuits 100 of FIG. 1.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

References may be made in the claims to a transistor's control input and its current terminals. In the context of a BJT, the control input is the base, and the current terminals are the collector and emitter.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A bandgap reference circuit, comprising:
a first diode-coupled transistor having a first control terminal and first and second current terminals;
a second transistor having a second control terminal and third and fourth current terminals, the second control terminal coupled to the first control terminal;
a third transistor having a third control terminal and fifth and sixth current terminals;
a fourth diode-coupled transistor having a fourth control terminal and seventh and eighth current terminals, the fourth control terminal coupled to the third control terminal;
an operational amplifier (OP AMP) having a first input, a second input, and an output, the output coupled to the first current terminal;
a first resistor coupled between the output and the third current terminal; and
a second resistor coupled between the sixth and eighth current terminals.

2. The bandgap reference circuit of claim 1, further comprising a third resistor coupled between the eighth current terminal and a reference terminal.

3. The bandgap reference circuit of claim 1, wherein the second input is coupled to the fourth and seventh current terminals.

4. The bandgap reference circuit of claim 1, further comprising:
a fifth transistor having a fifth control terminal and ninth and tenth current terminals, the fifth control terminal coupled to the first control terminal;
a third resistor coupled between the output and the ninth current terminal; and
a sixth diode-coupled transistor having eleventh and twelfth current terminals, the eleventh current terminal coupled to the tenth current terminal and to the second input.

5. The bandgap reference circuit of claim 4, further comprising:
a seventh transistor having a seventh control terminal and thirteenth and fourteenth current terminals, the seventh control terminal coupled to the fourth control terminal;
a fifth resistor coupled between the eighth current terminal and the fourteenth current terminal; and
an eighth diode-coupled transistor having fifteenth and sixteenth current terminals, the sixteenth current terminal coupled to the thirteenth current terminal and to the first input.

6. The bandgap reference circuit of claim 4, wherein a size of the fifth transistor is smaller than a size of the first diode-coupled transistor.

7. The bandgap reference circuit of claim 1, further comprising:
a fifth transistor having a fifth control terminal and ninth and tenth current terminals, the fifth control terminal coupled to the fourth control terminal;
a third resistor coupled between the eighth current terminal and the tenth current terminal; and
a sixth transistor having a sixth control terminal and eleventh and twelfth current terminals, the twelfth current terminal coupled to the ninth current terminal and to the first input.

8. The bandgap reference circuit of claim 1, wherein:
the first diode-coupled transistor and the second transistor are PNP bipolar junction transistors; and
the third transistor and the fourth diode-coupled transistor are NPN bipolar junction transistors.

9. A bandgap reference circuit, comprising:
an operation amplifier having a first input, a second input, and an output;
a current mirror loop having a first current mirror loop terminal, a second current mirror loop terminal, a first voltage terminal, and a second voltage terminal, the first current mirror loop terminal coupled to the first input, and the second current mirror loop terminal coupled to the second input, the first voltage terminal coupled to the output; and
a first resistor coupled between the second voltage terminal and a reference terminal.

10. The bandgap reference circuit of claim 9, wherein the current mirror loop comprises:
a first diode-coupled transistor having a first control terminal and first and second current terminals;
a second transistor having a second control terminal and third and fourth current terminals, the second control terminal coupled to the first control terminal;
a third transistor having a third control terminal and fifth and sixth current terminals;
a fourth diode-coupled transistor having a fourth control terminal and seventh and eighth current terminals, the fourth control terminal coupled to the third control terminal;
a second resistor coupled between the output and the third current terminal; and
a third resistor coupled between the sixth current terminal and the first resistor.

11. The bandgap reference circuit of claim 10, wherein the first diode-coupled transistor, the second transistor, the third transistor, and the fourth diode-coupled transistor are each bipolar junction transistors.

12. The bandgap reference circuit of claim 10, wherein the first diode-coupled transistor and the second transistor are one of PNP or NPN bipolar junction transistors, and the third transistor and the fourth diode-coupled transistor are the other of the PNP or NPN bipolar junction transistors.

13. The bandgap reference circuit of claim 10, wherein the first diode-coupled transistor and the fourth diode-coupled transistor are PNP bipolar junction transistors.

14. A bandgap reference circuit, comprising:
an operation amplifier having a first input, a second input, and an output;
a current mirror loop having a first voltage terminal and a second voltage terminal, the first voltage terminal coupled to the output, the current mirror loop including a first transistor having a control input;
a first resistor coupled between the second voltage terminal and a reference terminal;
a second transistor having a control input coupled to the control input of the first transistor such that a current through the first transistor is mirrored through the second transistor, the second transistor having a current terminal coupled to the second input; and
a third diode-coupled transistor coupled between the second transistor and the reference terminal.

15. The bandgap reference circuit of claim 14, wherein the current mirror loop includes a fourth transistor having a control input, and the bandgap reference circuit further comprises:
a fifth transistor having a control input coupled to the control input of the fourth transistor such that a current through the fourth transistor is mirrored through the fifth transistor, the fifth transistor having a current terminal coupled to the first input; and
a sixth diode-coupled transistor coupled between the output and the fifth transistor.

16. The bandgap reference circuit of claim 15, wherein a size of the second transistor is smaller than a size of the first transistor, and a size of the fifth transistor is smaller than a size of the fourth transistor.

17. The bandgap reference circuit of claim 15, wherein the sixth diode-coupled transistor and the third diode-coupled transistor are PNP bipolar junction transistors.

18. The bandgap reference circuit of claim 14, wherein the first transistor is a diode-coupled transistor having first and second current terminals, and the current mirror loop comprises:
a fourth transistor having a second control terminal and third and fourth current terminals, the second control terminal coupled to the control input of the first transistor;
a fifth transistor having a third control terminal and fifth and sixth current terminals;
a sixth diode-coupled transistor having a fourth control terminal and seventh and eighth current terminals, the fourth control terminal coupled to the third control terminal;
a second resistor coupled between the output and the third current terminal; and
a third resistor coupled between the sixth current terminal and the first resistor.

19. The bandgap reference circuit of claim 14, wherein the first transistor and the third diode-coupled transistor are PNP bipolar junction transistors.

20. The bandgap reference circuit of claim 14, wherein the first transistor is a diode-coupled transistor.
